(19) United States
(12) Patent Application Publication
(10) Pub. No.: US 2012/0286439 A1
(43) Pub. Date: Nov. 15, 2012

(54) PREPARATION OF PARTICULATE POSITIVE ELECTRODE MATERIAL FOR LITHIUM ION CELLS

(75) Inventors: Toshihiro Tsumori, Echizen-shi (JP); Yasushi Takai, Echizen-shi (JP)

(73) Assignee: SHIN-ETSU CHEMICAL CO., LTD., Tokyo (JP)

(21) Appl. No.: 13/462,033

(22) Filed: May 2, 2012

(30) Foreign Application Priority Data
May 13, 2011 (JP) 2011-108116

(51) Int. Cl. H01M 4/08; B29B 9/00

(52) U.S. Cl. 264/12; 264/5

(57) ABSTRACT

A particulate positive electrode material for lithium ion cells is prepared by dispersing manganese(II) sulfate, iron(II) sulfate, and lithium phosphate and/or lithium hydrogenphosphate in water to form a slurry, effecting hydrothermal reaction in an autoclave to synthesize a lithium compound: LiMnₓFe₁₋ₓPO₄ wherein x=0.05 to 0.5 as primary particles, preparing a dispersion comprising the primary particles and an organic substance, spraying the dispersion, granulating, and drying to form aggregated particles having an average particle size of 0.5-4 μm, and firing the aggregated particles at 600-780° C. for carbonizing the organic substance therein, yielding secondary particles having a reduced carbon content.

### CROSS-REFERENCE TO RELATED APPLICATION

This non-provisional application claims priority under 35 U.S.C. §119(a) on Patent Application No. 2011-108116 filed in Japan on May 13, 2011, the entire contents of which are hereby incorporated by reference.

### TECHNICAL FIELD

This invention relates to a method for preparing a particulate positive electrode material for lithium ion cells, typically in high current flow applications.

### BACKGROUND ART

While prior art secondary batteries including lead-acid batteries and Ni—Cd batteries rely on charge/discharge operations via ionization reaction of hydrogen (H→H⁺+e⁻) and migration of protons in aqueous electrolyte, lithium ion cells rely on charge/discharge operations via ionization of lithium (Li→Li⁺+e⁻) and migration of lithium ions in organic electrolyte. Since lithium metal has a potential of 3 volts versus the standard oxidation-reduction potential, the lithium ion cells allow for discharge at a higher voltage than the prior art secondary batteries.

Additionally, lithium responsible for oxidation-reduction is light. A combination of high discharge voltage with lightweight leads to a high energy density per unit mass, surpassing the prior art secondary batteries. The lithium ion cells characterized by lightweight and high capacity are widely used in laptop computers, mobile phones and other battery-built-in mobile instruments which are currently in common use. The utilization of the lithium ion cell is now extended to the outdoor use requiring high current flow discharge such as power tools, hybrid cars, and electric vehicles.

Lithium ion cell positive electrode materials, typically polyanionic positive electrode materials based on the structure of oxides such as PO₄, SiO₄ and BO₄, are improved in lifetime on repetitive charge/discharge operations, overcharge resistance, and stability on high-temperature exposure. Their properties are appropriate as the positive electrode material for outdoor use batteries and automobile batteries which require durability as well as high current flow discharge. On the other hand, the polyanionic materials have low electric conduction due to their structure. Thus, particles of the polyanionic material must be coated with carbon to form an electroconductive layer so that individual positive electrode material particles may be electrically conductive before the polyanionic material can be used as the battery material.

Of the polyanionic positive electrode materials, those compounds represented by LiMnₓFe₁₋ₓPO₄ are expected to find use in outdoor batteries because they have a robust PO₄ structure having a pyrolysis temperature close to 1,000° C. and good charge/discharge properties as the positive material as compared with polyanionic compounds having a SiO₄ structure.

### CITATION LIST

Patent Document 1: JP-A 2006-032241

### SUMMARY OF INVENTION

An object of the invention is to provide a method for preparing a particulate positive electrode material for lithium ion cells, by which a particulate polyanionic positive electrode material represented by LiMnₓFe₁₋ₓPO₄ is obtainable as a positive electrode material capable of affording an excellent charge/discharge capacity at high current condition to a lithium ion cell.

The inventors have found that a particulate positive electrode material can be prepared by (1) mixing and dispersing manganese(II) sulfate, iron(II) sulfate, and lithium phosphate and/or lithium hydrogenphosphate in water to form a slurry at pH 5 to 9, (2) feeding the slurry into an autoclave and effecting hydrothermal reaction therein at a temperature of 130 to 180° C. to synthesize a lithium compound having the formula (1):

LiMnₓFe₁₋ₓPO₄ (1)

wherein x is a positive number of 0.05 to 0.5, as primary particles, (3) preparing a particle dispersion comprising the primary particles and 4% to 40% by weight of an organic substance based on the weight of the primary particles, spraying the dispersion as mist, granulating, and drying, through a spray dryer, for example, obtaining aggregated particles having an average particle size of 0.5 μm to 4 μm, and (4) firing the aggregated particles at a temperature of 600° C. to 780° C. for carbonizing the organic substance therein, yielding secondary particles having a carbon content corresponding to 30% to 70% by weight of the carbon content of the aggregated particles prior to the firing step. The resulting secondary particles are the particulate positive electrode material represented by LiMnₓFe₁₋ₓPO₄ and capable of affording an excellent charge/discharge capacity at high current condition to a lithium ion cell.

Accordingly, the invention provides a method for preparing a particulate positive electrode material for lithium ion cells, comprising the steps of:

mixing and dispersing manganese(II) sulfate, iron(II) sulfate, and lithium phosphate and/or lithium hydrogenphosphate in water to form a slurry at pH 5 to 9,

feeding the slurry into an autoclave and effecting hydrothermal reaction therein at a temperature of 130 to 180° C. to synthesize a lithium compound having the formula

LiMnₓFe₁₋ₓPO₄ (1)

wherein x is a positive number of 0.05 to 0.5, as primary particles,

preparing a particle dispersion comprising the primary particles and 4% to 40% by weight of an organic substance based on the weight of the primary particles, spraying the dispersion as mist, granulating, and drying, obtaining aggregated particles having an average particle size of 0.5 μm to 4 μm, and

firing the aggregated particles at a temperature of 600° C. to 780° C. for carbonizing the organic substance therein, yielding secondary particles having a carbon content corresponding to 30% to 70% by weight of the carbon content of the aggregated particles prior to the firing step.

Typically, the step of spraying the dispersion, granulating, and drying is performed by a spray dryer with fluid spraying nozzles.

### ADVANTAGEOUS EFFECTS OF INVENTION

By the method of the invention, a particulate polyanionic positive material represented by LiMnₓFe₁₋ₓPO₄ is obtainable as a positive electrode material capable of affording an excellent charge/discharge capacity at high current condition when used in a lithium ion cell. The lithium ion cell using the particulate positive electrode material is suited in the high current flow application.

### BRIEF DESCRIPTION OF DRAWINGS

FIG. 1 is a SEM micrograph of particulate positive material (secondary particles) obtained in Example 1.

FIG. 2 is a graph showing a discharge power capacity per unit mass of particulate positive material relative to discharge rate of test cells in Example 1 and Comparative Examples 1 and 3.

### DESCRIPTION OF EMBODIMENTS

The invention is directed to the synthesis of a lithium compound having the formula (1):

LiMnₓFe₁₋ₓPO₄ (1)

wherein x is a positive number of 0.05 to 0.5, as a positive electrode material for lithium ion cells.

For the polyanionic positive electrode material represented by LiMnₓFe₁₋ₓPO₄, the discharge voltage during charge/discharge operation becomes lower as the ratio of Fe to Mn increases, and the initial discharge voltage reaches 3.4 V (versus Li negative electrode) when manganese free (x=0). A cell using manganese-free compound has a low electromotive force. On the other hand, iron-free compound (x=1) offers a high initial discharge voltage of 4.1 V (versus Li negative electrode), but is undesirable from the aspect of cell life. This is because in the fully charged state, Li is completely ionized and desorbed, and the positive electrode material becomes a MnPO₄ single layer, leading to a likelihood of manganese being dissolved out. For these reasons, in order that the composition be practically acceptable, a proportion of Mn relative to the sum of Fe and Mn ranges from 5 mol % to 50 mol %, that is, x in formula (1) has a value of 0.05 to 0.5.

The particulate positive electrode material for lithium ion cells is prepared by first mixing and dispersing manganese(II) sulfate, iron(II) sulfate, and lithium phosphate and/or lithium hydrogenphosphate in water to form a suspension or slurry. The amounts of manganese(II) sulfate, iron(II) sulfate, and lithium phosphate and/or lithium hydrogenphosphate used may be determined in accordance with the composition of the lithium compound having formula (1). In particular, water is preferably used in an amount sufficient to dissolve manganese(II) sulfate and iron(II) sulfate whereby the components are mixed and dispersed therein.

The slurry, exactly the solution portion of the slurry is at pH 5 or higher, especially pH 6.5 or higher and pH 9 or lower, especially pH 8 or lower. If the slurry is below pH 5, synthesis of a lithium compound having formula (1) is extremely retarded during hydrothermal reaction to be described later. If the pH of the slurry exceeds 9, more hydroxide forms during hydrothermal reaction, and so the slurry becomes a semi-solid gel, impeding uniform reaction. The pH of the slurry may be adjusted by adding lithium hydroxide, ammonia or the like, if necessary.

In the second step, the slurry is fed into an autoclave or airtight pressure vessel where hydrothermal reaction is carried out to synthesize a lithium compound having the formula (1) as primary particles. The temperature of hydrothermal reaction is at least 130° C., especially at least 135° C., and up to 180° C., especially up to 170° C. If the temperature of hydrothermal reaction is below 130° C., the reaction rate is extremely low. At higher temperatures, the properties of the resulting lithium compound are not adversely affected. However, when the temperature exceeds 180° C., the vessel must be resistant to a pressure in excess of 1 MPa. From the practical aspect, the temperature is equal to or lower than 180° C. The time of hydrothermal reaction is typically 1 hour to 72 hours though not particularly limited. By this hydrothermal reaction, the lithium compound having formula (1) is synthesized as primary particles. After hydrothermal reaction, particles of the lithium compound having formula (1) are separated from the slurry by a solid-liquid separation technique such as centrifugation or filtration. The primary particles typically have an average particle size of 0.2 μm to 2 μm. As used herein and throughout the disclosure, the term “average particle size” refers to a median diameter (D₅₀: particle size at 50% cumulative size distribution) as measured by a particle size distribution measuring system using laser diffractometry.

In the third step, a particle dispersion comprising the primary particles of the lithium compound having formula (1) and an organic substance is prepared. The particle dispersion is sprayed as mist, granulated, and dried to form aggregated particles having an average particle size of 0.5 μm to 4 μm.

If the slurry of primary particles of the lithium compound having formula (1) in water is mixed directly with an organic substance such as sucrose serving as a carbon source, some inconvenience arises. When water is removed therefrom by centrifugation or filtration, a substantial fraction of the organic substance is removed together with the water. When the thus coated particles are subsequently fired for carbonization, the resulting positive material particles are less electroconductive due to a shortage of carbon on the particle surface. Also a great difference in electric conduction can arise between lots of positive material particles. The primary particles resulting from hydrothermal synthesis are extremely fine and thus difficult to handle because they readily agglomerate together or consolidate during the step of firing a mixture of the primary particles and an organic substance and the subsequent steps of the cell manufacture process, for example.

In the practice of the invention, once the primary particles of the lithium compound having formula (1) are separated after hydrothermal synthesis, the primary particles are dispersed in water again to form a dispersion. At this point, the primary particles are combined with an organic substance in an amount of at least 4% by weight, especially at least 5% by weight and up to 40% by weight, especially up to 30% by weight, based on the weight of the primary particles. Notably the organic substance on primary particles is to be fired for carbonization. In the invention, the dispersion of the primary particles and organic substance is sprayed and dried to form aggregated particles having a plurality of primary particles agglomerated (i.e., organic substance-laden aggregated particles), after which the aggregated particles are fired whereby carbonization takes place in the substantially uniformly mixed state of organic substance and primary particles. As a result, positive material particles (or secondary particles) having satisfactory electric conduction and a minimal variation thereof are obtainable. Examples of the organic substance to be added to the dispersion include saccharides such as sucrose and glucose, ascorbic acid, polyethylene glycol, and tetraethylene glycol, with preference being given to water-soluble organic substances, especially water-soluble organic substances consisting of carbon, hydrogen and oxygen.

If the aggregated particles have a large particle size, they are easy to handle in the cell electrode manufacturing process, but charge/discharge performance as the positive electrode material becomes poorer in proportion to an increasing particle size. It is believed that the charge/discharge performance is degraded because aggregated particles of a large particle size tend to undergo a different degree of carbonization between the surface layer and the interior during firing although the reason is not limited thereto. On the other hand, if the aggregated particles have too small a particle size, they are difficult to handle in the cell electrode manufacturing process, and in the subsequent firing step, partial fusion can occur between adjacent aggregated particles and thus, the particle size distribution at the end of firing becomes extraordinarily non-uniform. For these reasons, the aggregated particles should have an average particle size of 0.5 μm to 4 μm.

The step of spraying the primary particle dispersion as mist, granulating, and drying to form aggregated particles having an average particle size of 0.5 μm to 4 μm is preferably performed by a spray dryer, especially a spray dryer with fluid spraying nozzles.

The fluid spraying/drying technique is a technique of spraying a fluid as fine mist on a carrier of compressed air being injected and drying in hot air, and is successful in forming finer secondary particles than the mechanical granulating/drying technique such as atomizer. The fluid spraying/drying system includes two, four and multiple fluid nozzle systems depending on the number of injection nozzles, any of which can be used herein. Although the fluid spraying/drying system of any type can form aggregated particles having an average particle size of 0.5 μm to 4 μm, a spray dryer with four fluid nozzles is preferably used for forming uniform and fine secondary particles. The conditions (including primary particle concentration, organic substance concentration, dispersion flow rate, drying gas flow rate, and drying temperature) under which the particle dispersion is sprayed and dried by the spray dryer may be suitably determined in accordance with the structure of spray dryer so that the average particle size of aggregated particles may fall in the desired range.

From the aspect of forming aggregated particles having an average particle size of 0.5 μm to 4 μm, it is important that the amount of the organic substance added to the dispersion be in the range of 4 to 40% by weight of the primary particles. If the amount of the organic substance is too small, the bond force of binding primary particles together during spray drying becomes short, making it difficult to form aggregated particles. If the amount of the organic substance is too large, there is a likelihood of aggregated particles fusing together during drying, resulting in secondary particles lacking particle size uniformity, and even a likelihood that many aggregated particles further agglomerate together into extremely large aggregated particles.

Finally the aggregated particles are fired, yielding secondary particles as the particulate positive electrode material. The firing step is carried out to carbonize the organic substance binding primary particles together in the aggregated particles for converting it into a conductive carbon coating. Firing is preferably carried out in an oxygen-free atmosphere, for example, an inert gas atmosphere, typically argon, in order to prevent the organic substance and primary particles from combustion and oxidation upon heating. The firing temperature is at least 600° C., especially at least 650° C. and up to 780° C., especially up to 750° C. If the firing temperature is below 600° C., the carbon resulting from the organic substance has too low a crystallinity to provide conduction. If the firing temperature is above 780° C., not only carbonization and recrystallization reactions take place, but also undesirable reduction and decomposition reactions of the lithium compound having formula (1) as the positive electrode material can take place.

In the firing step, the organic substance in the aggregated particles should be carbonized to reduce the carbon content of secondary particles to at least 30% by weight, especially at least 40% by weight, and up to 70% by weight, especially up to 60% by weight of the carbon content of the aggregated particles prior to the firing step. If the firing step causes carbonization to such an extent that the residual carbon content at the end of firing step does not fall in the defined range, a lithium ion cell using the resulting particulate positive electrode material is unsatisfactory in that the charge/discharge capacity is considerably low during charge/discharge operation at a high rate in excess of 1 C, especially discharge operation at such a high current flow value that the fully charged electricity quantity is discharged within one hour.

It is not well understood why the positive electrode material varies its properties depending on the degree of volatilization of carbon during the firing step. If the amount of carbon volatilized off exceeds 70% by weight, the carbon near primary particles in the surface layer of secondary particles at the end of firing is substantially extinguished and thus electric conduction is locally reduced. If the amount of carbon volatilized off is less than 30% by weight, few nano-size voids are created in the carbide structure formed as a result of volatilization of decomposable components of the organic substance, that is, a dense carbon film is formed. The dense carbon film covers the surface of a primary particle to prevent diffusion of electrolyte or Li⁺ ion. These reasons are presumable although the reason is not limited thereto.

In the firing step, the soaking time, especially constant temperature treatment time within the above-defined treatment temperature range is typically several tens of minutes to several hours although the time varies with many factors including the heating and cooling schedules, firing vessel, flow rate and pressure of the surrounding inert gas.

Typically the particulate positive electrode material as secondary particles has a carbon content of 2% to 15% by weight based on the weight of the positive electrode material (lithium compound) and an average particle size of 0.5 μm to 4 μm.

### EXAMPLE

Examples of the invention are given below by way of illustration and not by way of limitation.

### Example 1

One (1) mole of lithium phosphate, 0.5 mole of iron(II) sulfate, and 0.5 mole of manganese(II) sulfate were mixed in 1 L of water, and agitated for 30 minutes to form a mixed slurry at pH 6.7. The slurry was fed into an autoclave where it was heated at 150° C. for 20 hours to effect hydrothermal reaction to synthesize a lithium compound LiMn_{0.5}Fe_{0.5}PO₄ as primary particles.

The primary particles of the lithium compound were mixed and dispersed in 1.5 L of water together with 20% by weight of sucrose based on the weight of the primary particles. By operating a spray dryer with four fluid nozzles (Fujisaki Electric Co., Ltd.) at a dispersion dropping rate of 20 ml/min and an air blow flow rate of 80 L/min, the dispersion was spayed as mist, granulated and dried, obtaining sucrose-laden aggregated particles having an average particle size of 2 μm. The carbon content of the sucrose-laden aggregated particles was measured to be 8.1% of the weight of the positive electrode material (lithium compound).

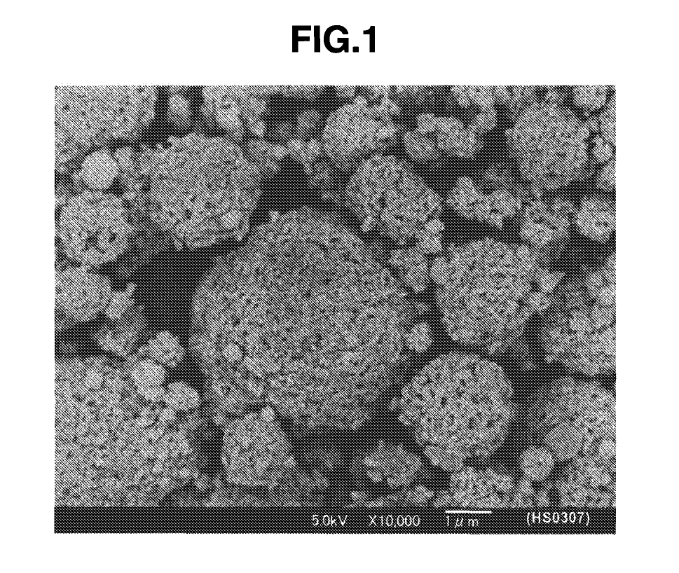

The sucrose-laden aggregated particles were fired in an Ar stream at 740° C. for 60 minutes, yielding particulate positive electrode material (secondary particles) having an average particle size of 2.5 μm. FIG. 1 is a SEM micrograph of the secondary particles. The carbon content of the secondary particles was measured to be 4.6% of the weight of the positive electrode material (lithium compound), indicating that 43.1% of the initial carbon content was volatilized off.

The carbide state in the particulate positive electrode material (secondary particles) was examined by X-ray diffractometry. Although the carbide did not have so high crystallinity, it had a lattice spacing in [002] plane of 0.39±0.01 nm, which was greater than the lattice spacing of graphite equal to 0.335 nm.

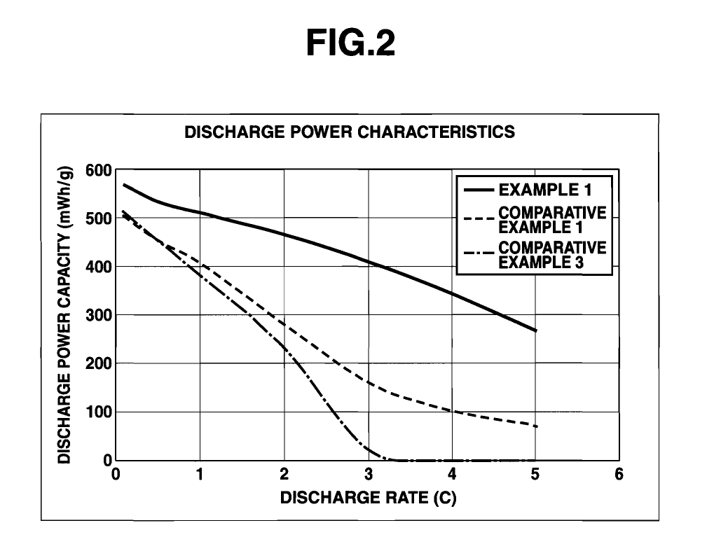

The particulate positive electrode material (secondary particles) was mixed with Ketjen Black (Mikuni Color Ltd.) and polyvinylidene fluoride (PVDF) in N-methyl-2-pyrrolidone. The mix was coated onto an aluminum current collector and dried to form a positive electrode material sheet. A CR2032 coin type test cell was assembled using metallic lithium as negative electrode and the positive electrode material sheet as positive electrode, and evaluated for a power capacity per unit mass of the particulate positive electrode material (secondary particles) during low rate and high rate charge/discharge operations. The results are shown in the diagram of FIG. 2. The cell showed a capacity of 580 mWh/g during charge/discharge at a low rate of 0.1 C. The cell also showed a capacity of 276 mWh/g during charge/discharge at a high rate of 5 C, maintaining 48% of the capacity during low rate charge/discharge.

### Comparative Example 1

One (1) mole of lithium phosphate, 0.5 mole of iron(II) sulfate, and 0.5 mole of manganese(II) sulfate were mixed in 1 L of water, and agitated for 30 minutes to form a mixed slurry at pH 6.7. The slurry was fed into an autoclave where it was heated at 150° C. for 20 hours to effect hydrothermal reaction to synthesize a lithium compound LiMn_{0.5}Fe_{0.5}PO₄ as primary particles.

The primary particles of the lithium compound were mixed and dispersed in 1.5 L of water together with 20% by weight of sucrose based on the weight of the primary particles. The dispersion was dried for 24 hours in a rotary kiln (laboratory rotary kiln RK-0330 by Motoyama Co., Ltd.) at 50° C. The resulting mixture in flake form was ground on a mortar and screen sieved, obtaining sucrose-laden aggregated particles having an average particle size of 4.2 μm. The carbon content of the sucrose-laden aggregated particles was measured to be 8.3% of the weight of the positive electrode material (lithium compound).

The sucrose-laden aggregated particles were fired in an Ar stream at 780° C. for 30 minutes, yielding particulate positive electrode material (secondary particles) having an average particle size of 4.5 μm. The carbon content of the secondary particles was measured to be 6.0% of the weight of the positive electrode material (lithium compound), indicating that 28.2% of the initial carbon content was volatilized off.

Using the resulting particulate positive electrode material (secondary particles), a CR2032 coin type test cell was assembled as in Example 1. The cell was evaluated for a power capacity per unit mass of the particulate positive electrode material (secondary particles) during low rate and high rate charge/discharge operations. The results are also shown in the diagram of FIG. 2. The cell showed a capacity of 510 mWh/g during charge/discharge at a low rate of 0.1 C, which was about 88% of the capacity in Example 1. The cell also showed a capacity of 80 mWh/g during charge/discharge at a high rate of 5 C, which was about 29% of the capacity in Example 1.

### Comparative Example 2

One (1) mole of lithium phosphate, 0.5 mole of iron(II) sulfate, and 0.5 mole of manganese(II) sulfate were mixed in 1 L of water, and agitated for 30 minutes to form a mixed slurry at pH 6.7. The slurry was fed into an autoclave where it was heated at 150° C. for 20 hours to effect hydrothermal reaction to synthesize a lithium compound LiMn_{0.5}Fe_{0.5}PO₄ as primary particles.

The primary particles of the lithium compound were mixed and dispersed in 1.5 L of water together with 20% by weight of sucrose based on the weight of the primary particles. The dispersion was granulated and dried by a rotary atomizer type spray dryer (GEA Niro by GEA Process Engineering), obtaining sucrose-laden aggregated particles having an average particle size of 4.8 μm. The carbon content of the sucrose-laden aggregated particles was measured to be 7.8% of the weight of the positive electrode material (lithium compound).

The sucrose-laden aggregated particles were fired in an Ar stream at 800° C. for 30 minutes, yielding particulate positive electrode material (secondary particles) having an average particle size of 5 μm. The carbon content of the secondary particles was measured to be 2.2% of the weight of the positive electrode material (lithium compound), indicating that 72% of the initial carbon content was volatilized off.

Using the resulting particulate positive electrode material (secondary particles), a CR2032 coin type test cell was assembled as in Example 1. The cell was evaluated for a power capacity per unit mass of the particulate positive electrode material (secondary particles) during low rate and high rate charge/discharge operations. The cell showed a capacity of 350 mWh/g during charge/discharge at a low rate of 0.1 C, which was about 60% of the capacity in Example 1. The cell also showed a capacity of 30 mWh/g during charge/discharge at a high rate of 5 C, which was about 11% of the capacity in Example 1.

### Comparative Example 3

Using commercially available carbon-coated LiFePO₄ particles (SEI Corp.), a CR2032 coin type test cell was assembled as in Example 1. The cell was evaluated for a power capacity per unit mass of the particulate positive electrode material (secondary particles) during low rate and high rate charge/discharge operations. The results are also shown in the diagram of FIG. 2. The cell showed a capacity of 504 mWh/g during charge/discharge at a low rate of 0.1 C, which was about 87% of the capacity in Example 1. The cell also showed a capacity of substantially 0 mWh/g during charge/discharge at a high rate of 5 C.

Japanese Patent Application No. 2011-108116 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for preparing a particulate positive electrode material for lithium ion cells, comprising the steps of:
mixing and dispersing manganese(II) sulfate, iron(II) sulfate, and lithium phosphate and/or lithium hydrogenphosphate in water to form a slurry at pH 5 to 9,
feeding the slurry into an autoclave and effecting hydrothermal reaction therein at a temperature of 130 to 180° C. to synthesize a lithium compound having the formula (1):
LiMnₓFe₁₋ₓPO₄ (1)
wherein x is a positive number of 0.05 to 0.5, as primary particles,
preparing a particle dispersion comprising the primary particles and 4% to 40% by weight of an organic substance based on the weight of the primary particles, spraying the dispersion as mist, granulating, and drying, obtaining aggregated particles having an average particle size of 0.5 μm to 4 μm, and
firing the aggregated particles at a temperature of 600° C. to 780° C. for carbonizing the organic substance therein, yielding secondary particles having a carbon content corresponding to 30% to 70% by weight of the carbon content of the aggregated particles prior to the firing step.

2. The method of claim 1 wherein the step of spraying the dispersion, granulating, and drying is performed by a spray dryer with fluid spraying nozzles.
